(19) United States
(12) Patent Application Publication
(10) Pub. No.: US 2022/0105459 A1
(43) Pub. Date: Apr. 7, 2022

(54) AIR PURIFIER

(71) Applicants: Vikram Sharma, Pleasanton, CA (US); Ritu Sharma, Pleasanton, CA (US); Ria Sharma, Pleasanton, CA (US); Aarush Sharma, Pleasanton, CA (US); Anika Sharma, Pleasanton, CA (US)

(72) Inventors: Vikram Sharma, Pleasanton, CA (US); Ritu Sharma, Pleasanton, CA (US); Ria Sharma, Pleasanton, CA (US); Aarush Sharma, Pleasanton, CA (US); Anika Sharma, Pleasanton, CA (US)

(21) Appl. No.: 17/553,766

(22) Filed: Dec. 16, 2021

(51) Int. Cl. B01D 47/06; B01D 53/26; B01D 50/60; C02F 1/02; C02F 1/00; F24F 1/0083

(52) U.S. Cl. CPC B01D 47/06; B01D 53/261; B01D 50/60; C02F 2209/02; C02F 1/008; F24F 1/0083; C02F 1/02

(57) ABSTRACT

The present invention provides an air purifier. The air purifier is economical and reliable. The air purifier uses water to purify air. The air purifier provides a provision for killing bacteria, algae and prevents mosquitoes from breeding in the water of the air purifier. The purifier includes a housing, an air inlet, an air outlet, an air flow channel, an air driving means and an air exhaust means, a fluid reservoir, a heating module, at least one nozzle, a tray and a fluid drive means. More particularly, in the present invention an atmospheric air is sucked into the air flow channel by the air driving means, wherein the air stream passes under a fluid spray, whereupon a dust particles, pollutants and particulate matters are absorbed by the fluid coming in contact with it and the filtered air exits through the air outlet.

### TECHNICAL FIELD OF INVENTION

The present invention relates to an air purifier. More particularly, the present invention relates to an air purifier used in an isolation room in hospitals, in operating rooms, in factories, in rooms in homes and offices, and the like that purifies the air by spraying fluid (water or alkaline water) in order to separate the particulate matter present in the air in an enclosed space.

### BACKGROUND

Many different devices and methods for separating particles from a gas flow are known. Such devices are also called air purifiers. Such air purifiers are, for example, used in isolation rooms in hospitals, in operating rooms, in factories, in rooms in homes and offices, and the like.

Air impurities and the health issues caused by impure air or air containing higher level of particulate matter has increased considerably in recent years. Research has shown that gaseous and particulate matters are environmental exposure agents that clearly increase sickness and health issues. The problems are worst in large cities, in which emissions from traffic and energy production pollute the air. Besides the health issues, impurities in outdoor air also affect the corrosion and oxidation of materials.

In order to combat the progressively worsening air quality in urban settlements, various inventions have been proposed worldwide. Following are some of the attempts made.

CN108656904A describes an air purifier and vehicle that to the field of air purification, and in particular to an air purifier, an air purification method, and a vehicle using the same. More particularly, the air purifier includes a purifier body having an intake port and an exhaust port, wherein the purifier body is provided with a rain flow generating device, the air to be purified and the intake port enters the purifier body and passes through a top-down rain flow generated by the rain flow generating device for purification, and then is discharged from the exhaust port.

CN204502662U describes an air purifier that is currently used to solve due to indoor poor ventilation, indoor living environment problem has not reached the people requested. The purifier includes a separator, the separator chamber side of the spray chamber, the exhaust chamber mounted ventilation fans, top discharge chamber outlet is provided, the cavity beneath the water separator, a water submersible pumps; spray chamber is provided with an upper air intake and a removable filter.

U.S. Pat. No. 1,248,631A describes an indoor air purifier that has a base and a container on the base with a layer of soil supported above a lower water bath occupying the bottom of the container. Room air is drawn into the base and is passed from the base into the bottom of the container through a duct connected between the two. Air passing from the base is directed downwardly into the water bath before passing upwardly into the soil layer. The water bath humidifies the air being passed through it and maintains a stable degree of moisture in the lower portion of the soil layer. Water lost through evaporation is replenished through a sleeve passing downward from the soil's surface to the water bath.

Thus, in the view of above prior art, it can be understood that many air purifiers have been designed in an attempt to provide similar air purifying solution, however when water is used for purifying air, it can cause the temperature of the space/room to drop and also increase the moisture in the air. Also standing water can become breeding ground for algae, bacteria and even mosquitos.

In the light of foregoing, there is need for an air purifier that overcomes problems prevalent in the prior art.

### SUMMARY

The present invention provides an air purifier. The air purifier uses fluid to purify the air. The fluid is water or alkaline water. The purifier includes a housing, an air inlet, an air outlet, an air flow channel, an air driving and an air exhaust means, a fluid reservoir, a heating module, at least one nozzle, a tray, and a fluid drive means.

In one embodiment of the present invention, the air flow channel is formed within the housing between the air inlet and the air outlet. The air flows through the air flow channel. The air driving means pulls in the air from the outside into the air flow channel. The air exhaust means pulls out or exhaust out purified air from the air flow channel to the outside. The air driving and the air exhaust means are a fan or a ventilator or a blower.

In one embodiment of the present invention, the fluid reservoir stores a fluid. The fluid reservoir is provided at a bottom of the air flow channel. In an alternative embodiment, the fluid reservoir is provided at a top of the air flow channel. The heating module is configured with the reservoir. The heating module heats the fluid to a required temperature selected by the user. Further, the heating module kills any algae, bacteria or mosquito eggs in the water. The heating module includes temperature sensors, heating element and a controller. The temperature sensor senses the liquid temperature. One more temperature sensor senses the outside temperature. The controller activates or deactivates the heating element for heating the fluid based on a difference calculated between the sensed outside temperature and the sensed fluid temperature. When the outside temperature is configured to be less than or equal to the fluid temperature, the controller deactivates the heating element. Similarly, when the outside temperature is configured to be more than the fluid temperature, the controller activates the heating element to heat the fluid. In one more embodiment, the heating module is provided with a knob for setting a required temperature as per a user's requirement.

In one embodiment of the present invention, the nozzle is arranged into the air flow channel along a top surface. The nozzle introduces the fluid in spray form to the air flow channel to mix with the passing air. When the fluid mixes with the water, the water collect particulate matter. The fluid reservoir receives fluid mixed with particulate matter. The fluid drive means is installed with the reservoir to drive fluid from the fluid reservoir to the nozzle. The fluid drive means is a pump. The tray is removably configured at a top of the housing. The tray holds hydrophilic material for absorbing moisture content in the purified air. The hydrophilic material is preferably baking soda or sugar or salt or starch or cellulose.

In an alternative embodiment, more than one air purifiers are arranged in a series for improving the air quality.

In one more alternative embodiment of the present invention, more than one nozzle is arranged in the air flow channel each at different height.

Further, in one more alternative embodiment, a dehumidifier is incorporated within the housing to maintain the moisture contained in the purified air as per requirement.

In one of the alternative embodiments of the present invention, a post filter is incorporated to reduce the amount of particulate matter in the already purified air.

These and other features and advantages along with other embodiments of the present invention will become apparent from the detailed description below, in light of the accompanying drawings.

Various objects, features, aspects and advantages of the present invention will become more apparent from the following detailed description of the embodiments of the invention, along with the accompanying drawings in which like numerals represent like components.

### BRIEF DESCRIPTION OF DRAWINGS

So that the manner in which the above-recited features of the present invention can be understood in detail, a more particular description of the invention, briefly summarized above, may have been referred by embodiments, some of which are illustrated in the appended drawings. It is to be noted, however, that the appended drawings illustrate only typical embodiments of this invention and are therefore not to be considered limiting of its scope, for the invention may admit to other equally effective embodiments.

These and other features, benefits, and advantages of the present invention will become apparent by reference to the following text figure, with like reference numbers referring to like structures across the views, wherein:

FIG. 1 shows an air purifier installed in an isolated room in accordance with the present invention;

FIG. 2 shows a schematic representation for an air purifier in accordance with the present invention;

FIG. 3 shows another schematic representation for an alternative embodiment for the air purifier in accordance with the present invention; and

FIG. 4 shows yet another schematic representation for a one more alternative embodiment for the air purifier in accordance with the present invention.

### DETAILED DESCRIPTION

Some embodiments, illustrating its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any methods, and systems similar or equivalent to those described herein can be used in the practice or testing of embodiments, the preferred methods, and systems are now described. The disclosed embodiments are merely exemplary.

The present invention is described hereinafter by various embodiments with reference to the accompanying drawing, wherein reference numerals used in the accompanying drawing correspond to the like elements throughout the description. This invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only and are not intended to limit the scope of the claims. In addition, several materials are identified as suitable for various facets of the implementations. These materials are to be treated as exemplary and are not intended to limit the scope of the invention.

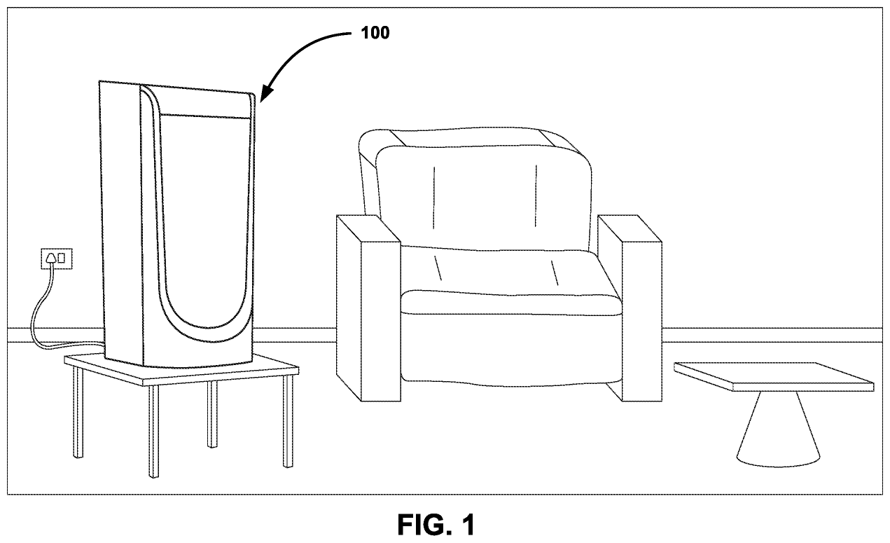

The various features and embodiments of the present invention will now be described in conjunction with the accompanying figures, namely FIGS. 1-4.

It is observed that after a rainfall, the Air quality index which is a measure of particulate matter in the air goes down. The same principle can be replicated in indoor spaces by passing air stream through a liquid (water) spray. The present invention uses the same principle which requires a fluid shower to purify the air. The present invention provides an air purifier. The air purifier is portable. The air purifier economical and more reliable. The air purifier provides a provision for killing the bacteria. Further, the air purifier maintains the air temperature to the room temperature and the moisture content.

From herein afterwards the air purifier 100 of the present invention is referred as the purifier 100. Ideally, the air purifier 100 works in an enclosed space. The air purifier 100 can be installed in the room as shown in FIG. 1. The air purifier 100 can be smaller than a small aquarium or as big as industrial rooms depending upon the space where the purifier may be deployed or installed.

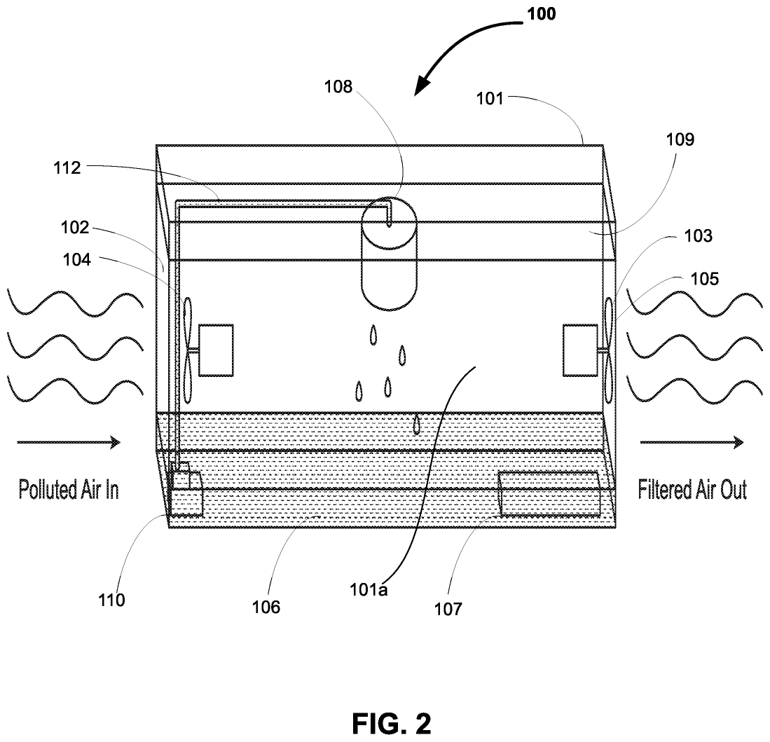

As well illustrated in FIG. 2, the purifier 100 includes a housing 101, an air inlet 102, an air outlet 103, an air flow channel 101a, an air driving means 104, an air exhaust means 105, a fluid reservoir 106, a heating module 107, at least one nozzle 108, a tray 109 and a fluid drive means 110.

The air purifier 100 includes the air driving means 104 which is installed at the air inlet 102. The air driving means 104 is a fan or a ventilator or a blower. The air driving means 104 is configured to draw the outside (atmospheric) air into the hollow space of the air flow channel 101a, as shown in the FIG. 2. The outside air includes dust particles, pollutants and particulate matters. Sometimes, the outside air includes bacterium that can affect a human health.

The air flow channel 101a is formed within the housing 101 between the air inlet 102 and the air outlet 103. In the preferred embodiment the air flow channel 101a is a horizontal between the air inlet 102 and the air outlet 103. In an alternative embodiment the air flow channel 101a is formed in a way to gradually raise in height from the air inlet 102 to the air outlet 103. In an alternative embodiment, the air flow channel 101a may be configured as a zigzag passage made between air inlet 102 and the air outlet 103. The air flows through the air flow channel 101a. The air exhaust means 105 pulls or exhaust out purified air from the air flow channel 101a to the outside. The air driving means 104 and the air exhaust means 105 comprises but not limited to a fan or a ventilator or a blower.

The fluid reservoir 106 stores a fluid. The fluid includes water or an alkaline water. The alkaline water neutralizes the acidic particulates in the air. The fluid reservoir 106 is fluid storage tank that hold desired volume of the fluid. The fluid reservoir 106 is provided at a bottom of the air flow channel 101a or at the bottom of housing 101. In an alternative embodiment, the fluid reservoir 106 may be configured installed at a top of the air flow channel 101a. The inlet of the fluid reservoir 106 may be further provided with known filters in order to filter the fluid entering therein.

The heating module 107 is configured in the vicinity of the reservoir 106. The heating module 107 uses an external power source for achieving the heating effect. The heating module 107 heats the fluid to a required temperature in order to kill the bacteria, algae and mosquitoes or other harmful organisms that may be present in the stored fluid in the reservoir 106. The heating module 107 includes a heater, one or more temperature sensors and a controller. The most common temperature sensors used are Resistance Temperature Detector (RTD), a thermistor and a thermocouple. The temperature sensor senses the fluid temperature stored in the fluid reservoir 106. One more temperature sensor configured for sensing the outside temperature (atmospheric temperature). The controller is connected to the temperature sensors and the heater using a communication module. The communication module is a wired communication module or a wireless communication module. The controller receives the sensed temperatures from the temperature sensors. The controller activates or deactivates the heating module 107 for heating the fluid based on a difference between the sensed outside temperature and the sensed fluid temperature. In an alternative embodiment, the controller includes a timer circuit, thereby enabling the controller to activate the heating module 107 for a required time period and then deactivate the same and then after certain time repeats the same process.

When the outside temperature is set to less than or equal to the fluid temperature, the controller deactivates the heating module 107. Similarly, when the outside temperature is set to more than the fluid temperature, the controller activates the heating unit to heat the fluid to the outside temperature. In one more embodiment, the heating module 107 may be provided with a knob or button (not seen) or a press button or a lever or an electromechanical switch or an electromagnetic switch for setting a required temperature and a time. Upon operating the knob/button, the user can adjust the purified air temperature as per his comfort. In one more embodiment, the user can set the temperature using a remote method such as a smartphone application.

The fluid drive means 110 is installed within the housing 101 to drive fluid from the fluid reservoir 106 to the nozzle 108 through a network of ducts 112. The fluid drive means 110 is a pump or a submersible pump. The pump is operated using an external power source. The nozzle 108 is arranged into the air flow channel 101a along a top surface of the air flow channel 101a to a required height. The nozzle 108 is provided with small holes in order to introduce the fluid in spray form to the air flow channel 101a.

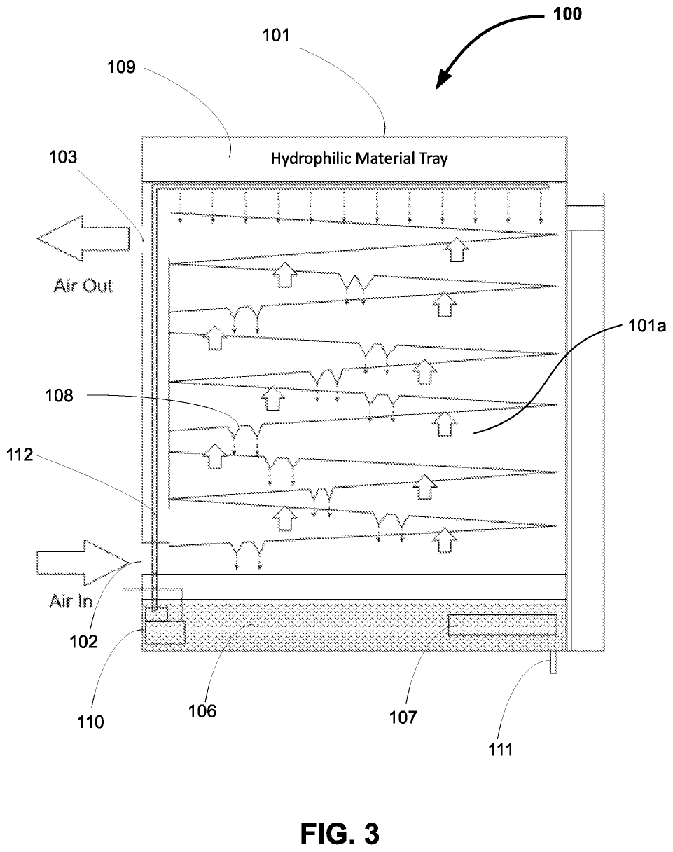

In another embodiment, there might be multiple nozzles 108 in series to increase the surface of contact between the polluted air and fluid sprayed. In one more alternative embodiment of the present invention as well illustrated in FIG. 3, more than one nozzle 108 is arranged in the air flow channel 101a each at different height and/or different angle.

The direction of fluid from the nozzle 108 is perpendicular or at an angle to the passing air stream. When the fluid passes through the air passing through the air flow channel 101a, the dust and other pollutants/particles present in the air are absorbed by the water droplets as the air flow makes it way towards the air outlet 103. As the water droplets form a continuous spray, the air flow will remain in contact with the water droplets, therein getting purified the pollutants and dust particles, until air reaches the air outlet 103. The air flow exits the purifier 100 through the air flow channel 101a at the air outlet 103.

As shown in FIG. 3, the tray 109 is removably installed at the top of the housing 101. The tray 109 holds hydrophilic material for absorbing moisture content in the purified air. The hydrophilic material may include baking soda or sugar or salt or starch or cellulose or any combinations thereof. In the preferred embodiment, the hydrophilic material used is the salt. If there is a high moisture in the room due to the operation of the air purifier 100, the hydrophilic material will absorb the moisture from the air. The tray 109 of salt can later be kept in the sunlight so the fluid evaporates and the tray 109 can be re-used.

The dust and other pollutants absorbed by the water droplets eventually get collected in the fluid reservoir 106 again. In an alternative embodiment, the fluid reservoir 106 is provided with a floating dust filter (not shown), that receives the dust particles from the air. Once the dust filter gets saturated with the dirt deposits, the dust filter may be removed and cleaned before installing back in the fluid reservoir 106. The used fluid may be removed using fluid outlet 111.

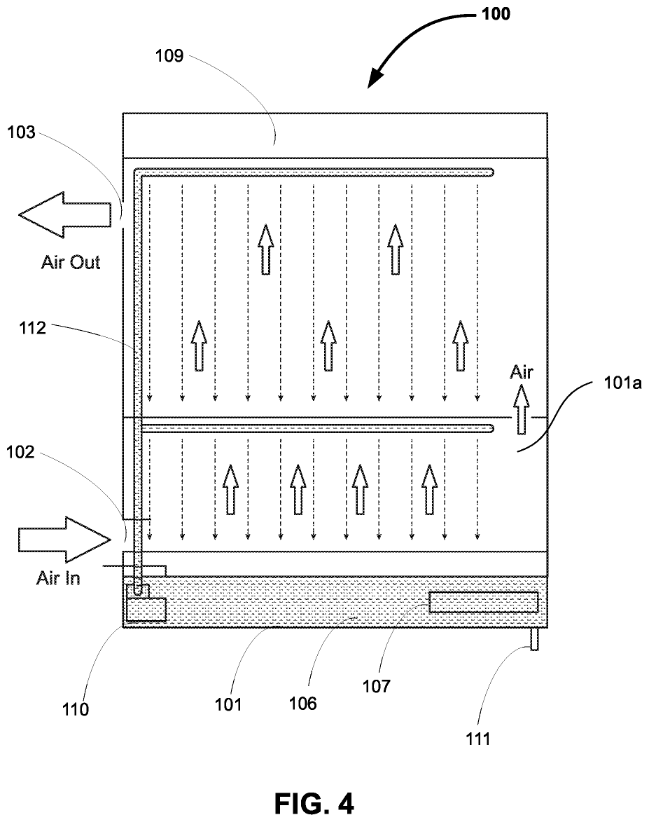

In an alternative embodiment as well disclosed in FIG. 4, more than one air purifiers 100 are arranged in a series. The series arrangement of air purifiers 100 improves the air quality and reduces the particulate matter in the air.

Further, in one more alternative embodiment, a dehumidifier (not shown) may be incorporated within the housing 101 to maintain the moisture contained in the purified air as per requirement. Also, the air purifier 100 may be provided with an odor sensor (not shown) for sensing the concentration of odor in the air. Further, the fluid may be provided with added fragrance.

In one of the alternative embodiments of the present invention, a post filter (not shown) may additionally be incorporated near the air outlet 102 for passing the purified air therethrough before exiting the air outlet 103.

In one of the alternative embodiments of the present invention, a pre-filter (not shown) may be incorporated to reduce the amount of particulate matter in the absorbed air entering the air inlet 102.

The present invention provides an advantage of providing the air purifier 100 that can be installed within the room as shown in FIG. 1. The air purifier 100 is portable. The air purifier 100 is economical and reliable. The air purifier 100 provides a provision for killing the bacteria. Further, the air purifier 100 maintains the air temperature to the room temperature and the moisture content. The air purifier 100 provides a provision for recycling the water and hydrophilic material. A fragrance can be added to air by using this device. The air purifier 100 is simple in construction and easy to operate. The air periodically heats the fluid to a high temperature to prevent algae, bacteria or prevent fluid from becoming a breeding ground for mosquitoes. The air purifier 100 improves the health of a user by providing a good quality of air for breathing. Further, the air purifier 100 saves materials from an unnecessary corrosion and oxidation as hazardous chemical particles in the air are removed.

It should be understood according to the preceding description of the present invention that the same is susceptible to changes, modifications and adaptations, and that the said changes, modifications and adaptations fall within scope of the appended claims.

What is claimed is:

1. An air purifier (100) comprising:
a housing (101);
an air inlet (102);
an air outlet (103);
wherein an air flow channel (101a) is formed within the housing (101) between the air inlet (102) and the air outlet (103),
an air driving means (104) and an air exhaust means (105) to drive the air through the air flow channel (101a);
a fluid reservoir (106) that stores the fluid and the fluid mixed with the particulate matter;
wherein a heating module (107) configured therewith heats the fluid to a required temperature;
at least one nozzle (108) into the air flow channel (101a) to introduce the fluid in spray form to the air flow channel (101a) to mix with the passing air and collect particulate matter;
a fluid drive means (110) to drive the fluid from the fluid reservoir (106) to the nozzle (108) through a duct (112); and
a tray (109) that holds a hydrophilic material for absorbing a moisture content in a purified air.

2. The air purifier (100) of claim 1, wherein the fluid is water or alkaline water.

3. The air purifier (100) of claim 1, wherein the fluid reservoir (106) is provided at bottom of the air flow channel (101a).

4. The air purifier (100) of claim 1, wherein the fluid reservoir (106) is provided with a fluid outlet (111).

5. The air purifier (100) of claim 1, wherein the heating module (107) comprises at least one temperature sensor to sense an outside (atmospheric) temperature.

6. The air purifier (100) of claim 1, wherein the heating module (107) comprises at least one temperature sensor to sense the liquid temperature.

7. The air purifier (100) of claim 5, wherein the temperature sensor comprises a Resistance Temperature Detector (RTD) or a thermistor or a thermocouple.

8. The air purifier (100) of claim 1, wherein the heating module (107) includes a controller for activating or deactivating the heating module (107) for heating the fluid based on a difference between the sensed outside temperature and the sensed fluid temperature.

9. The air purifier (100) of claim 1, wherein when the outside temperature is less than or equal to the fluid temperature, the controller deactivates the heating unit.

10. The air purifier (100) of claim 1, wherein when the outside temperature is more than the fluid temperature, the controller activates the heating unit to heat the fluid to the outside temperature in order to achieve a room temperature.

11. The air purifier (100) of claim 1, wherein the air driving means (104) and the air exhaust means (105) comprises a fan or a ventilator or a blower.

12. The air purifier (100) of claim 1, wherein the fluid drive means (110) is a pump or a submersible pump.

13. The air purifier (100) of claim 1, wherein more than one air purifiers (100) are arranged in a series.

14. The air purifier (100) of claim 1, wherein more than one nozzle (108) is arranged in a series in the air flow channel (101a) each at a different or at a same height.

15. The air purifier (100) of claim 1 further comprising a dehumidifier is incorporated within the housing (101) to maintain the moisture contained in the purified air as per requirement.

16. The air purifier (100) of claim 1 further comprising a post filter is incorporated to reduce the amount of particulate matter in the purified air.

17. The air purifier (100) of claim 1 further comprising a pre-filter is incorporated to reduce the amount of particulate matter in the absorbed air.

18. The air purifier (100) of claim 1, wherein the hydrophilic material comprises baking soda or sugar or salt or starch or cellulose.

19. The air purifier (100) of claim 1, wherein the tray (109) is removably configured within the housing (101).

20. The air purifier (100) of claim 1, wherein the heating module (107) includes a knob or a press button or a lever or an electromechanical switch or an electromagnetic switch for setting a required temperature.
